(19) United States
(12) Patent Application Publication
(10) Pub. No.: US 2010/0302995 A1
(43) Pub. Date: Dec. 2, 2010

(54) ROUTER APPARATUS

(75) Inventor: Yasuhiro Morioka, Kawasaki-shi (JP)

Correspondence Address: PATTERSON & SHERIDAN, L.L.P., 3040 POST OAK BOULEVARD, SUITE 1500, HOUSTON, TX, 77056, US

(73) Assignee: KABUSHIKI KAISHA TOSHIBA, Tokyo (JP)

(21) Appl. No.: 12/705,079

(22) Filed: Feb. 12, 2010

(30) Foreign Application Priority Data
May 29, 2009 (JP) 2009-131567

(51) Int. Cl. H04J 3/08

(52) U.S. Cl. 370/315

(57) ABSTRACT

A router apparatus is for establishing, in a home network system comprising a plurality of subnetworks including a first subnetwork and a second subnetwork, connection between the respective subnetworks. The router apparatus includes: a first network interface configured to be connected to a first communication device existing on the first subnetwork; a second network interface configured to be connected to a second communication device existing on the second subnetwork; a determination module configured to determine whether a function advertisement notification related to a router device is received from the first communication device; and a providing module configured to provide, to the second communication device, information included in the function advertisement notification received from the first communication device when the determination module determines that the function advertisement notification related to the router device is received.

### CROSS REFERENCE TO RELATED APPLICATION(S)

The present disclosure relates to the subject matters contained in Japanese Patent Application No. 2009-131567 filed on May 29, 2009, which are incorporated herein by reference in its entirety.

### FIELD

The present invention relates to a router apparatus capable of avoiding a malfunction caused by setting conflicting subnetworks in a home network.

### BACKGROUND

In recent years, a relay communication apparatus such as a router apparatus or the like has been widely used in ordinary households due to the development of communication technologies. In a general home network, external connection is often established using a broadband router. When a user newly installs a wireless LAN (Local Area Network) access point apparatus or the like having a routing function, for example, to a lower level of the broadband router in such a home network, installation and operation of this apparatus may be performed while the routing function thereof is kept enabled. At the time of shipment, the relay communication apparatus having such a routing function is often designed and initialized on the precondition that the apparatuses is used in a single subnetwork configuration. Therefore, when a plurality of subnetworks exist as a multi-stage router configuration on the home network as mentioned above, a trouble might occur in the management of the home network.

To cope with this trouble, there has been proposed a communication apparatus that transmits a search packet for making a search for a router apparatus existing at a higher level than the present apparatus in a home network in which a plurality of subnetworks exist, and that turns OFF the routing function of the present apparatus upon finding out of the router apparatus at a higher level, thereby changing the function so as to serve as a simple bridge apparatus. An example of such apparatus is disclosed in JP-A-2008-140209.

In the apparatus thus configured, a search packet is transmitted in order to find out a higher level router apparatus; however, when a search is made for a higher level router apparatus that is two or more stages higher, for example, this search is made on the precondition that the search packet and a reply packet thereof can pass through the immediately adjacent higher level router apparatus. But in actuality, router apparatuses for home use are generally operated in a simple subnetwork as described above, and there is a case where packets cannot pass through due to filtering functions of these router apparatuses. Further, since a search packet is transmitted to a higher level, the search packet might be transmitted out of the house, and neighboring houses within a same building might see the search packet, resulting in disadvantages in terms of security.

Furthermore, there is a case where a router apparatus transmits a notification for advertising the possession of a given function (which will be hereinafter referred to as a “function advertisement notification”) to a lower level device, but when subnetworks are set so as to be overlaid in a multi-stage router configuration, a function advertisement notification transmitted by a higher level router apparatus is filtered by the filtering function of a router apparatus existing at a lower level, thereby making it impossible for the function advertisement notification to pass through the lower level router apparatus. Therefore, a device, which exists at a lower level than the lower level router apparatus (i.e., which is connected to the lower level side of the lower level router apparatus), cannot receive the function advertisement notification transmitted by the higher level router apparatus. This function advertisement notification includes information necessary for a connected device to execute a given function of a router apparatus, and therefore, there is a malfunction that the device, which was unable to receive the function advertisement notification, cannot obtain the information of the higher level router apparatus.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a diagram illustrating one example of a home network system according to a first embodiment.

FIG. 2 is a block diagram illustrating one example of hardware configuration of a wireless LAN access point according to the first embodiment.

FIG. 3 is a functional block diagram illustrating one example of functional configuration of the wireless LAN access point according to the first embodiment.

FIG. 4 is a sequence diagram illustrating one example of the flow of communication in the home network system according to the first embodiment.

FIG. 5 is a diagram illustrating one example of a method for transferring advertisement packet information according to the first embodiment.

FIG. 6 is a flow chart illustrating one example of process flow of the wireless LAN access point according to the first embodiment.

FIG. 7 is a functional block diagram illustrating one example of functional configuration of a wireless LAN access point according to a first variation of the first embodiment.

FIG. 8 is a diagram illustrating one example of a method for transferring advertisement packet information according to the first variation of the first embodiment.

FIG. 9 is a flow chart illustrating one example of process flow of the wireless LAN access point according to the first variation of the first embodiment.

FIG. 10 is a functional block diagram illustrating one example of functional configuration of a wireless LAN access point according to a second variation of the first embodiment.

FIG. 11 is a sequence diagram illustrating one example of the flow of communication in a home network system according to the second variation of the first embodiment.

FIG. 12 is a diagram illustrating one example of a method for transferring advertisement packet information according to the second variation of the first embodiment.

FIG. 13 is a diagram illustrating one example of a UPnP IGD function setting page of the wireless LAN access point according to the second variation of the first embodiment.

FIG. 14 is a flow chart illustrating one example of process flow of the wireless LAN access point according to the second variation of the first embodiment.

### DETAILED DESCRIPTION OF THE EMBODIMENTS

Hereinafter, embodiments of the present invention will be described with reference to the drawings.

### First Embodiment

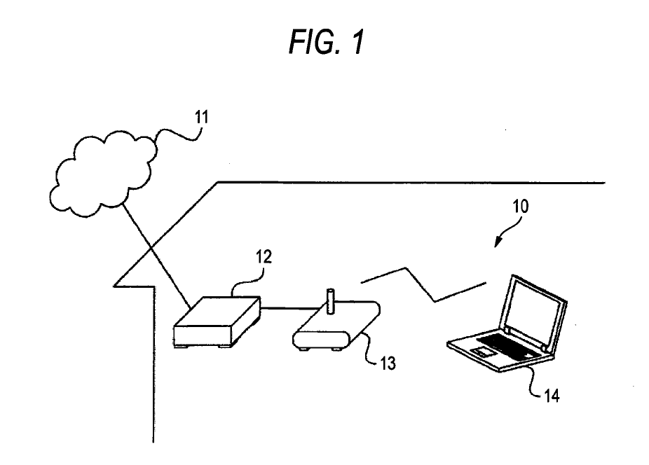

A first embodiment of a communication apparatus according to the present invention will be described with reference to FIGS. 1 to 6.

FIG. 1 is a diagram illustrating one example of a home network system 10 according to the present embodiment. As shown in FIG. 1, the home network system 10 includes a broadband router 12 connected to the Internet 11, a wireless LAN access point 13, and a PC 14.

In the present embodiment, the home network system 10 is a network system configured in a home and includes: the broadband router 12; the wireless LAN access point 13; and the PC 14. Since the broadband router 12 and the wireless LAN access point 13 each have a routing function, a multi-stage router configuration is provided, and two subnetworks are included in the home network system 10. Hereinafter, the description will be made on the assumption that the Internet 11 is at a higher level side in the home network system 10, and the PC 14 serving as a terminal device is at a lower level side in the home network system 10.

The Internet 11 is a WAN (Wide Area Network) and is capable of allowing communication between various communication devices connected thereto.

The broadband router 12 is a broadband router apparatus functioning as a communication device having a routing function for setting a transfer route for communication data as described above. The broadband router 12 has: a DHCP (Dynamic Host Configuration Protocol) server function for managing IP (Internet Protocol) address assignment; and a NAT (Network Address Translation) function, which is the function of performing mutual conversion between a private IP address and a global IP address. The broadband router 12 further has: a Web server function for enabling setting confirmation and/or modification via a lower level device; and a UPnP IGD (Universal Plug and Play Internet Gateway Device) function for enabling operation and/or setting of the NAT function via a lower level device. The broadband router 12 is connected to the Internet 11 via a higher level side communication interface, and is connected to the wireless LAN access point 13 via a lower level side communication interface, thus allowing the broadband router 12 to communicate with each of the Internet 11 and the wireless LAN access point 13.

The wireless LAN access point 13 is a router apparatus having a routing function, and serves as a wireless LAN access point capable of communicating with the PC 14 in accordance with wireless LAN standards. Moreover, similarly to the broadband router 12, the wireless LAN access point 13 has: a DHCP server function; a NAT function; a Web server function; and a UPnP IGD function. The wireless LAN access point 13 is communicably connected to the broadband router 12 via a higher level side communication interface, and is communicably connected to the PC 14 via a lower level side communication interface.

It should be noted that in this embodiment, the broadband router 12 and the wireless LAN access point 13 may each be a router apparatus having a routing function, and the case in which the components 12 and 13 are a broadband router and a wireless LAN access point, respectively, is illustrated by way of example in the present embodiment; however, the present invention is not limited to this case. This case is illustrated as an example in which a general user has added the wireless LAN access point 13 to the home network system 10 consisting only of the normal broadband router 12. When the home network system 10 is configured in this manner, a subnetwork is provided under the wireless LAN access point 13, and therefore, the two subnetworks exist in the home network system 10 as described above.

The PC 14 is an information processing apparatus such as a PC (Personal Computer), for example, and has the function of performing various information processing. The PC 14 is communicably connected to the wireless LAN access point 13. Furthermore, the PC 14 is accessible to a Web page of a communicable device, and upon reception of an advertisement packet, serving as a function advertisement notification storing functional information concerning a UPnP IGD function, from the other device, the PC 14 utilizes the information stored in this advertisement packet and uses the UPnP IGD function of the device that has transmitted the advertisement packet, thus enabling the operation and/or setting of the NAT function of this device. In the present embodiment, the PC 14 is illustrated as a PC, but is not limited to this as long as it is a device having the above-mentioned functions. In addition to the PC 14, other conceivable examples include various devices such as a DTV (Digital Television) and a PDA (Portable Digital Assistant).

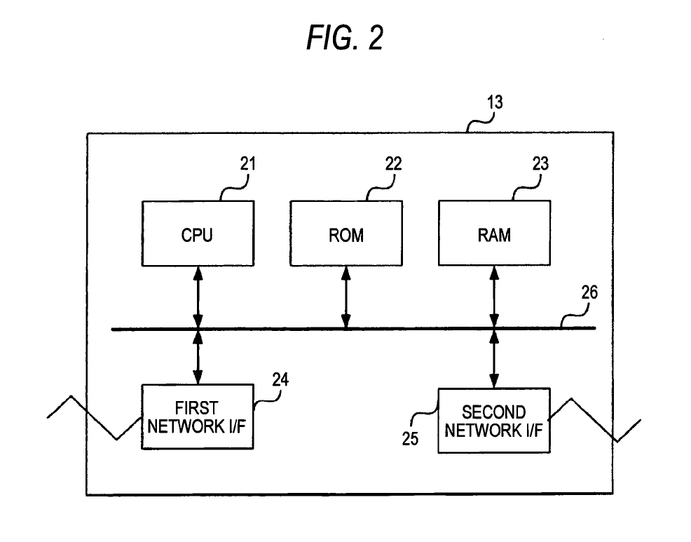

FIG. 2 is a block diagram illustrating one example of hardware configuration of the wireless LAN access point 13 according to the present embodiment. In FIG. 2, there are illustrated: the wireless LAN access point 13; a CPU 21; a ROM 22; a RAM 23; a first network interface 24 connected to WAN; a second network interface 25 connected to LAN; and a bus 26.

In the present embodiment, the wireless LAN access point 13 includes: the CPU 21; the ROM 22; the RAM 23; the first network interface 24; the second network interface 25; and the bus 26.

The CPU 21 is a CPU (Central Processing Unit), and controls the entire wireless LAN access point 13. The CPU 21 further has the functions of executing a program, and performing a given process in accordance with this program.

The ROM 22 is a ROM (Read Only Memory), for example, which is formed by a semiconductor memory, and stores the program to be executed by the CPU 21. In the present embodiment, the ROM 22 has: a routing application program for executing a routing function; a NAT application program for executing a NAT function; a Web server application program for executing a Web server function; and a UPnP IGD application program for executing a UPnP IGD function.

The RAM 23 is a RAM (Random Access Memory), for example, which is formed by a semiconductor memory, and the RAM 23 is utilized as a region in which program and data are expanded when the program is processed by the CPU 21.

The first network interface 24 is a first network interface for establishing communication and connection with a device existing at a higher level side of the wireless LAN access point 13, and in the present embodiment, the first network interface 24 is connected via a LAN cable to the broadband router 12 so as to have the function of performing data communication therewith.

The second network interface 25 is a second network interface for establishing communication and connection with a device existing at a lower level side of the wireless LAN access point 13, and in the present embodiment, the second network interface 25 has the function of performing communication with the PC 14 via a wireless LAN. Besides, in the present embodiment, the second network interface 25 performs communication with a plurality of devices including the PC 14.

Via the bus 26, the respective modules in the wireless LAN access point 13 are communicably connected to each other.

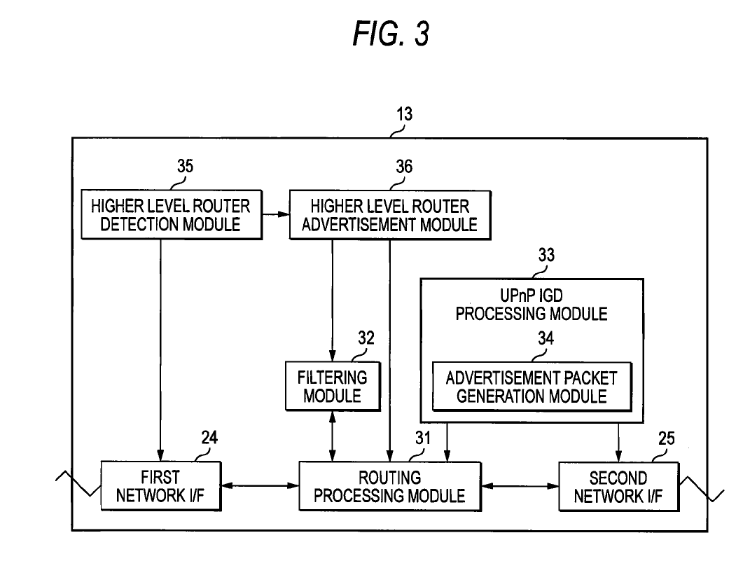

FIG. 3 is a functional block diagram illustrating one example of functional configuration of the wireless LAN access point 13 according to the present embodiment. In FIG. 3, there are illustrated: the wireless LAN access point 13; the first network interface 24; the second network interface 25; a routing processing module 31; a filtering module 32; a UPnP IGD processing module 33; an advertisement packet generation module 34; a higher level router detection module 35; and a higher level router advertisement module 36.

The routing processing module 31 has the functions of: obtaining a communication packet, which is transmitted from an external device and received by each of the interfaces of the first network interface 24 and the second network interface 25; and allowing each interface to transmit the obtained communication packet to an IP address of a target transfer destination. Furthermore, when a communication packets are received by this apparatus but no corresponding communication packet is transmitted from this apparatus, the routing processing module 31 performs a process of discarding the communication packet.

The filtering module 32 has the functions of: determining whether or not the communication packet obtained by the routing processing module 31 should be transferred; transmitting, when it is determined that the communication packet should be transferred, a transfer command to the routing processing module 31 so as to transfer the communication packet; and transmitting, when it is determined that the communication packet should not be transferred, a discard command (instruction) to the routing processing module 31 so as to discard the communication packet.

In the present embodiment, the UPnP IGD processing module 33 has the function of performing operation and/or setting of the NAT function of the wireless LAN access point 13 in response to a command received from the PC 14. In the present embodiment, each time a given period of time elapses, the UPnP IGD processing module 33 transmits an advertisement packet, which is a function advertisement notification storing operating information and the like resulting from the UPnP IGD function thereof, via the second network interface 25 to the PC 14 (i.e., the device that performs communication via the second network interface 25). This advertisement packet is generally transmitted by the router apparatus having a UPnP IGD function. The UPnP IGD processing module 33 includes the advertisement packet generation module 34.

The advertisement packet generation module 34 has the functions of generating and transmitting an advertisement packet that is transmitted by the UPnP IGD processing module 33. For example, the advertisement packet to be transmitted by the UPnP IGD processing module 33 stores pieces of information such as: a destination address; a destination port number; an advertisement packet expiration time; a location of a description page for a UPnP IGD function; a device type of the wireless LAN access point 13; information indicating whether or not the wireless LAN access point 13 has a UPnP IGD function; Web server information; and a UUID (Universally Unique Identifier) for identifying the UPnP IGD function of the wireless LAN access point 13. Exemplary partial description in the advertisement packet is given below.
NOTIFY*HTTP/1.1
HOST: 239.255.255.250:1900
CACHE-CONTROL: max-age=1800
LOCATION: http://192.168.190.1/description.xml
NT: urn:schemas-upnp-org:device:InternetGatewayDevice:1
NTS: ssdp:alive
SERVER: OS/Version UPnP/1.0 Product/Version
USN:uuid:550e8400-e29b-41d4-a716-446655440000::urn:sch emas-upnp-org:device:InternetGatewayDevice:1

Examples of pieces of information included in the above advertisement packet are as follows.

“The present advertisement packet is multicast to Port 1900 with a destination address of 239.255.255.250, and the expiration time is 1800 seconds. When access is made to http://192.168.190.1/description.xml, information concerning the UPnP IGD function of the wireless LAN access point 13 can be obtained. The UPnP IGD function of the wireless LAN access point 13 is available.”

These pieces of information are included in the description in the foregoing advertisement packet, and with the use of these pieces of information, the PC 14 can obtain the setting page of the UPnP IGD function of a router apparatus (which is information necessary for execution of a given function of a router apparatus in the present embodiment).

The wireless LAN access point 13 transmits, by multicasting, such an advertisement packet to a device connected to the second network interface 25. This multicast transmission is performed at regular time intervals in the present embodiment. Although the casein which the multicast transmission is performed at regular time intervals is illustrated by way of example in the present embodiment, the present invention is not limited to this example. Various examples are conceivable as to whether this multicast transmission is performed constantly or intermittently. Further, although the transmission of the advertisement packet is performed by multicast transmission in the present embodiment, the present invention is not limited to this.

The higher level router detection module 35 has the function of detecting reception of the advertisement packet when the wireless LAN access point 13 receives the advertisement packet concerning the UPnP IGD function via the first network interface 24. Upon reception of the advertisement packet by the first network interface 24, the higher level router detection module 35 detects the reception, and thus serves as a determination module for determining the existence of a router apparatus for the first network interface 24. After the determination, the higher level router detection module 35 notifies the higher level router advertisement module 36 that a router apparatus having a UPnP IGD function exists at a higher level. Since a router apparatus used outside a house normally has no UPnP IGD function, a router apparatus having a UPnP IGD function is one used in a home network, and the fact that a router apparatus used in a house exists at a higher level means that a subnetwork exists at a higher level.

The higher level router advertisement module 36 has the functions of: using the information stored in the advertisement packet received by the first network interface 24 upon reception of the notification that a router apparatus having a UPnP IGD function exists at a higher level from the higher level router detection module 35; and transmitting, to each associated functional block, a command for providing information for allowing the PC 14 to obtain the setting page of the broadband router 12. In the present embodiment, specifically, upon reception of the notification that a router apparatus exists at a higher level, the higher level router advertisement module 36 transmits a command to the filtering module 32 so as to prevent the filtering module 32 from performing filtering on the advertisement packet, and transmits a transmission command to the routing processing module 31 so as to allow the routing processing module 31 to perform multicast transmission of the advertisement packet via the second network interface 25. Even if initial settings are made so that filtering is performed on an advertisement packet, the filtering module 32 does not perform filtering on the advertisement packet upon reception of the command, and the routing processing module 31 transmits, by multicasting via the second network interface 25, the advertisement packet received by the first network interface 24. In this case, the higher level router advertisement module 36 and the routing processing module 31 serve as a transfer module.

When the router apparatus having a UPnP IGD function (which is the broadband router 12 in the present embodiment) exists at a higher level by providing the configuration as described above, the advertisement packet, which is transmitted by the higher level router apparatus via multicasting and received by the first network interface 24, can also be transferred to a device existing in a lower level subnetwork via the second network interface 25; thus, the lower level subnetwork device can also be notified of the existence of the router apparatus.

The broadband router 12 in the present embodiment is also illustrated as having an inner configuration substantially similar to that of the wireless LAN access point 13 by way of example. A difference between the broadband router 12 and the wireless LAN access point 13 is that the second network interface 25 of the wireless LAN access point 13 is a wireless LAN I/F, while that of the broadband router 12 is a wired I/F.

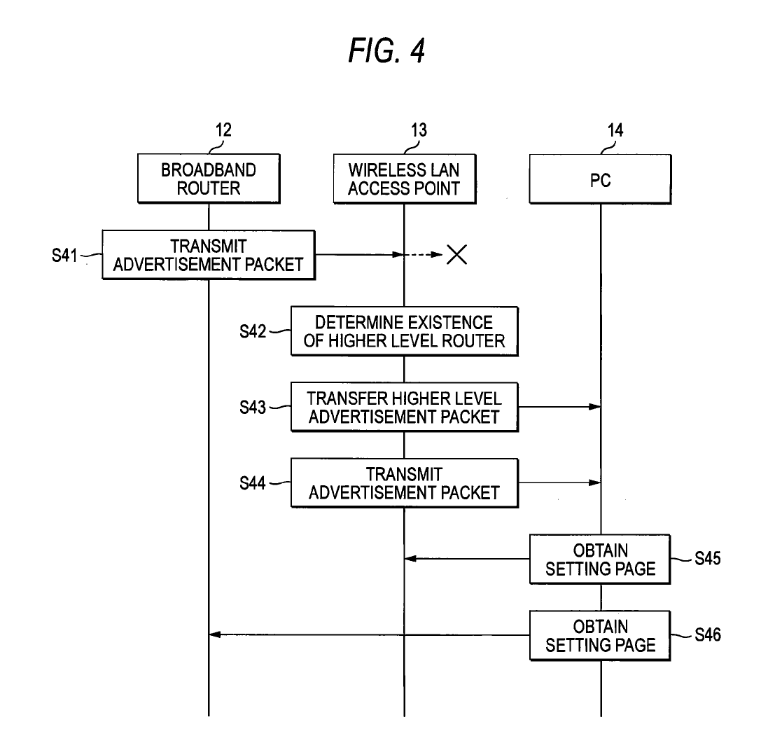

In the present embodiment, since the broadband router 12 also has a UPnP IGD function, the broadband router 12 transmits an advertisement packet concerning a UPnP IGD function via its second network interface 25, and the wireless LAN access point 13 receives this advertisement packet. These transmission and reception will be described with reference to FIG. 4 below.

FIG. 4 is a sequence diagram illustrating one example of the flow of communication in the home network system 10 according to the present embodiment.

Upon transmission of an advertisement packet concerning a UPnP IGD function by the broadband router 12 from its second network interface 25 to a device existing at a lower level (S41), the wireless LAN access point 13 receives the advertisement packet via its first network interface 24. Upon reception of the advertisement packet by the wireless LAN access point 13 via its first network interface 24, the higher level router detection module 35 detects the reception of a communication packet at the first network interface 24, and determines whether or not this communication packet is the advertisement packet. The higher level router detection module 35 determines whether or not the communication packet is the advertisement packet, and upon detection of the reception of the advertisement packet at the first network interface 24, the higher level router detection module 35 determines that a router apparatus having a UPnP IGD function exists at a higher level than the present apparatus (S42). After the existence of the higher level router has been determined, the wireless LAN access point 13 transfers the received advertisement packet to a device existing in a lower level subnetwork via the second network interface 25 (S43). Furthermore, the wireless LAN access point 13 transmits, at given time intervals, the advertisement packet concerning the UPnP IGD function of the present apparatus to the second network interface 25 (S44). Hence, the PC 14 existing in the lower level subnetwork can receive both of: the advertisement packet concerning the UPnP IGD function of the wireless LAN access point 13; and the advertisement packet concerning the UPnP IGD function of the broadband router 12 existing in the higher level subnetwork, and the PC 14 can thus obtain the setting pages of the wireless LAN access point 13 and the broadband router (S45, S46).

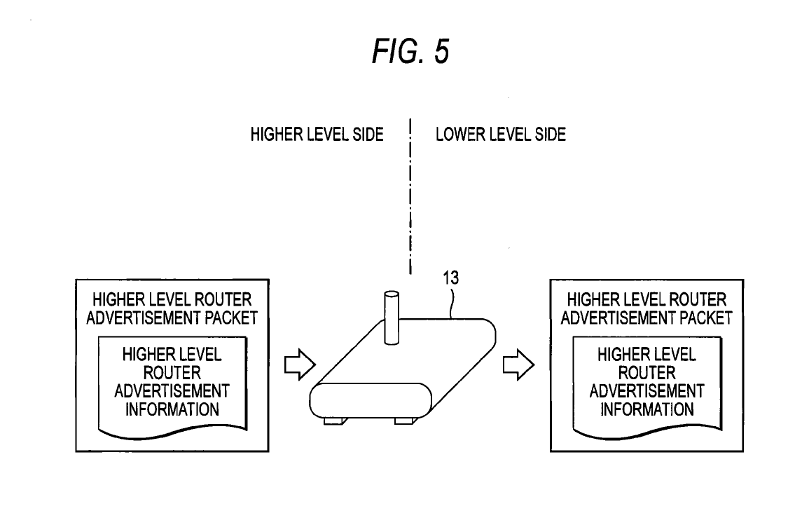

FIG. 5 is a diagram illustrating one example of a method for transferring advertisement packet information according to the present embodiment.

As illustrated in FIG. 5, the wireless LAN access point 13 transfers, to the device connected to the second network interface 25, the advertisement packet of the broadband router 12 (higher level router apparatus) in its original form, which is received via the first network interface 24.

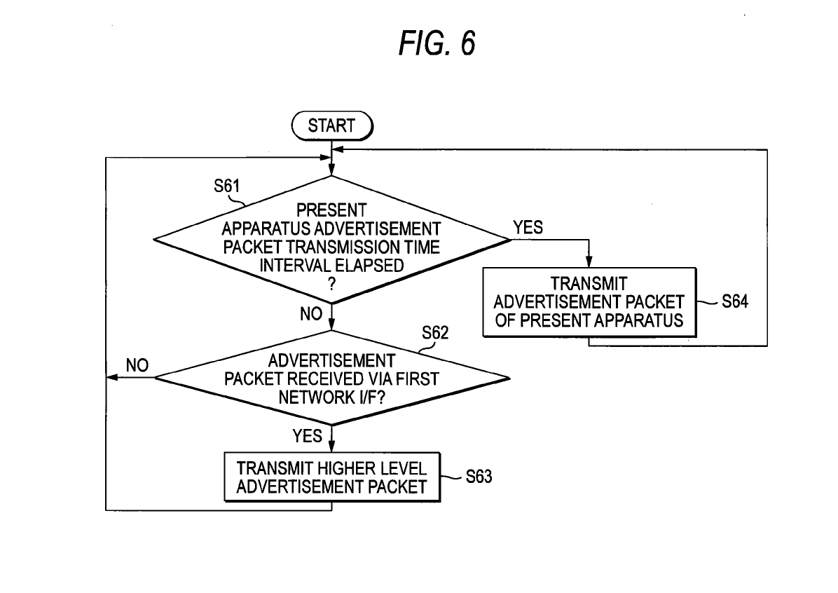

FIG. 6 is a flow chart illustrating one example of process flow of the wireless LAN access point 13 according to the present embodiment.

At given transmission time intervals, the wireless LAN access point 13 performs multicast transmission of the advertisement packet, concerning the UPnP IGD function of the present apparatus, to the device connected to its second network interface 25, and therefore, the UPnP IGD processing module 33 puts the transmission on standby during a given transmission time interval using a timer (not illustrated) of the UPnP IGD processing module 33 itself (S61). While the transmission is on standby during a given transmission time interval (i.e., when the answer is No in S61), the higher level router detection module 35 determines whether or not the advertisement packet concerning the UPnP IGD function should be received via the first network interface 24. Upon detection of reception of the advertisement packet via the first network interface 24 (i.e., when the answer is Yes in Step S62), the higher level router detection module 35 determines that a higher level router is connected to the first network interface 24, and notifies the higher level router advertisement module 36 of the existence of the higher level router. The higher level router advertisement module 36, which has received the notification, transmits a command to the filtering module 32 so as to prevent the filtering module 32 from performing filtering on the advertisement packet, and further transmits a command to the routing processing module 31 so as to transmit, by multicasting, the advertisement packet to the device connected to the second network interface 25. As a result of these processes, the advertisement packet received via the first network interface 24 is transferred to the device connected to the second network interface 25 (S63). When the reception of the advertisement packet is not detected via the first network interface 24 in S62 (i.e., when the answer is No in Step S62), and after the process of S63 has ended, the process flow returns to S61. Upon lapse of the transmission time interval in S61 (i.e., when the answer is Yes in Step S61), the UPnP IGD processing module 33 creates, in the advertisement packet generation module 34, an advertisement packet concerning the UPnP IGD function of the present apparatus, and performs multicast transmission of the generated advertisement packet of the present apparatus via the second network interface 25 (S64). Upon completion of the transmission, the process flow returns to S61 again. In this flow, the transfer of the advertisement packet of the higher level router apparatus, and the transmission of the advertisement packet of the present apparatus (wireless LAN access point 13) are handled asynchronously, but the present invention is not limited to this; alternatively, the transfer and the transmission may be handled synchronously.

In the process flow according to the present embodiment, the wireless LAN access point 13 detects the reception of the advertisement packet transmitted by the broadband router 12 and concerning the UPnP IGD function thereof via the first network interface 24, and can thus determine the existence of a router at a higher level. Besides, the wireless LAN access point 13 transfers the advertisement packet in its original form to the device (PC 14) connected to the second network interface 25 without performing filtering on this advertisement packet, thus allowing the device (PC 14) connected to the second network interface 25 to receive the advertisement packet of the higher level router apparatus (broadband router 12) existing on the different subnetwork. With the use of the information stored in this advertisement packet, the device (PC 14) connected to the second network interface 25 can be notified of the existence of the router apparatus (broadband router 12) provided at a higher level and the router apparatus provided with the UPnP IGD function, thus enabling the utilization of the UPnP IGD function of the router apparatus, and/or the utilization of functions for setting confirmation/modification provided via the a Web server function.

### First Variation of the First Embodiment

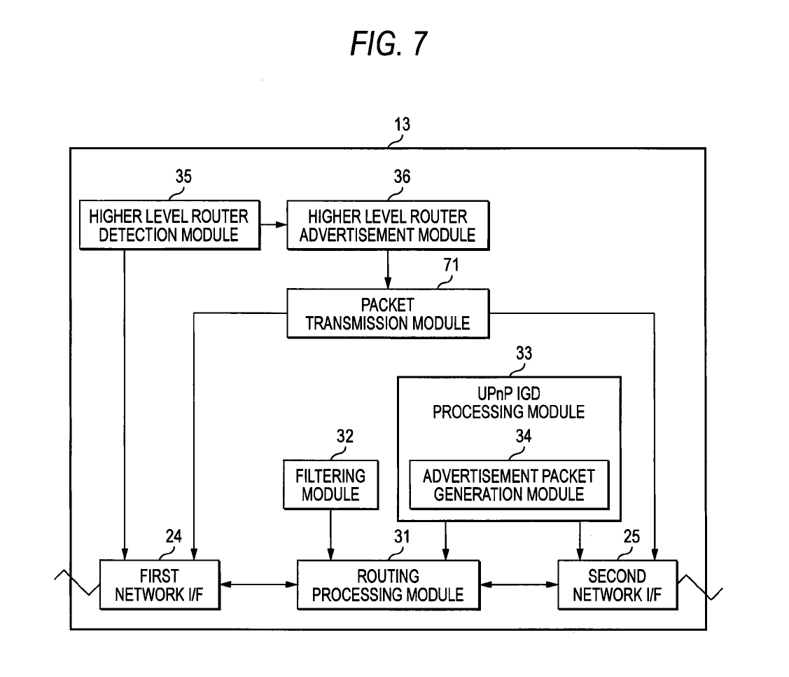

A first variation of the first embodiment according to the present invention will be described with reference to FIGS. 7 to 9.

This variation illustrates an example in which a wireless LAN access point 13 is also capable of coping with a case where a received advertisement packet is a communication packet that cannot be transferred.

In this variation, the configuration of a home network system 10 and the hardware configuration of respective devices are similar to those of the first embodiment, and therefore, the description thereof will be omitted. This variation will be described with emphasis on points different from the first embodiment.

FIG. 7 is a functional block diagram illustrating one example of functional configuration of the wireless LAN access point 13 according to this variation. In FIG. 7, there are illustrated: the wireless LAN access point 13; a first network interface 24; a second network interface 25; a routing processing module 31; a filtering module 32; a UPnP IGD processing module 33; an advertisement packet generation module 34; a higher level router detection module 35; a higher level router advertisement module 36; and a packet retransmission module 71.

The functional block configuration of the wireless LAN access point 13 according to this variation differs from that of the wireless LAN access point 13 according to the first embodiment in that the wireless LAN access point 13 includes, in addition to the functional blocks thereof in the first embodiment, the packet retransmission module 71. Hereinafter, in this variation, the description on the functional blocks having functions similar to those of the functional blocks in the first embodiment will be omitted, and the functional blocks having different functions will be mainly described.

Upon reception of a notification that a router apparatus having a UPnP IGD function exists at a higher level from the higher level router detection module 35, the higher level router advertisement module 36 transmits an instruction command to the packet retransmission module 71 so that the packet retransmission module 71 serves as a duplication module to duplicate an advertisement packet similar to the advertisement packet received by the first network interface 24, and serves as a duplication transmission module to transmit, by multicasting, the duplicated advertisement packet to the device connected via the second network interface 25.

Upon reception of the above-mentioned instruction command from the higher level router advertisement module 36, the packet retransmission module 71 obtains the advertisement packet received via the first network interface 24 in accordance with the command, duplicates an advertisement packet similar to the obtained packet, and transmits the duplicated advertisement packet by multicasting via the second network interface 25. In the present embodiment, the received advertisement packet is discarded after the similar advertisement packet has been generated.

The value “TTL (Time To Live)” is included in the header information of a packet, and this value indicates the number of times the packet can pass through a router apparatus. The value of the TTL is decremented by one each time the packet passes through the router apparatus, and when the router apparatus has received the packet having a TTL value of 1, this packet cannot be transferred any more. In this variation, instead of transferring the received packet, the packet retransmission module 71 duplicates and transmits a packet similar to the received packet; therefore, even if the TTL value of the received packet is 1, higher level advertisement packet information can be transmitted to the device (PC 14) connected to the second network interface 25.

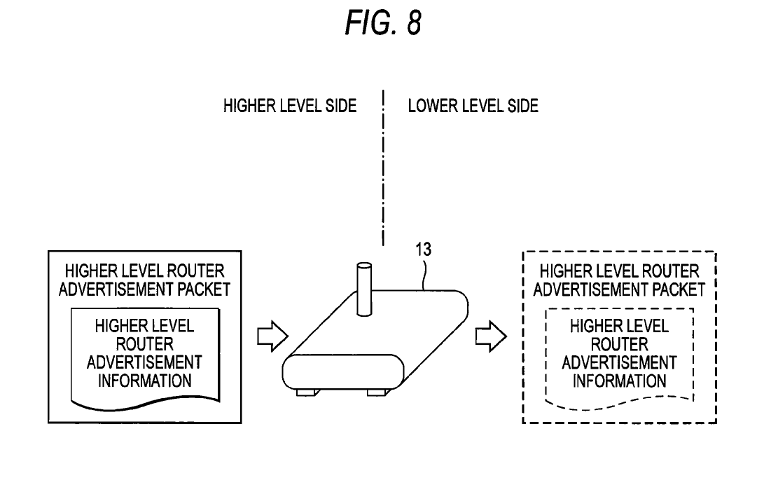

FIG. 8 is a diagram illustrating one example of a method for transferring advertisement packet information according to this variation.

As illustrated in FIG. 8, the wireless LAN access point 13 duplicates an advertisement packet similar to the advertisement packet of the broadband router 12 (higher level router apparatus) received via the first network interface 24, and transmits the duplicated advertisement packet to the device connected to the second network interface 25.

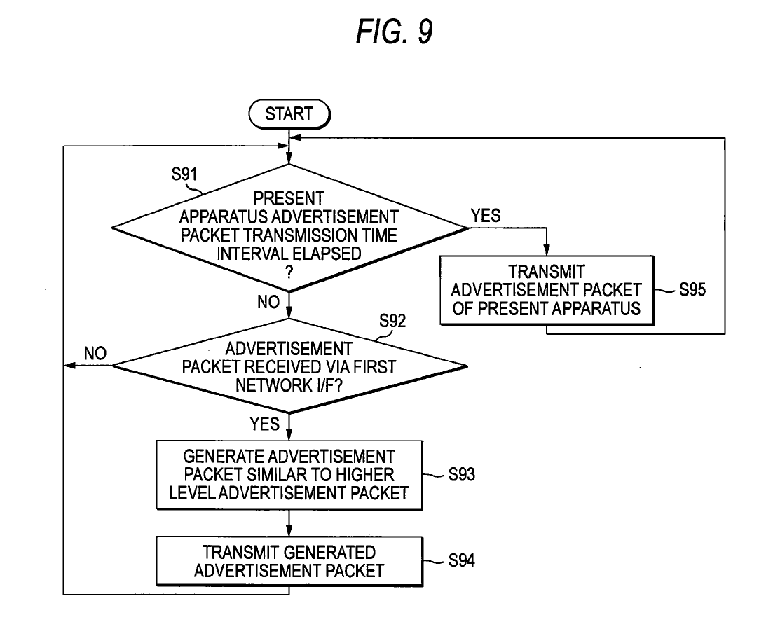

FIG. 9 is a flow chart illustrating one example of process flow of the wireless LAN access point 13 according to this variation. In the process flow of this variation, S91, S92 and S95 correspond to S61, S62 and S64 illustrated in FIG. 6 in the first embodiment, respectively, and therefore, the description thereof will be omitted.

The higher level router advertisement module 36, which has received the notification of the existence of a higher level router apparatus from the higher level router detection module 35 in S92, transmits an instruction command to the packet retransmission module 71 so that the packet retransmission module 71 duplicates, in S93, an advertisement packet similar to the advertisement packet received via the first network interface 24, and transmits the duplicated advertisement packet via the second network interface 25 by multicasting. Upon reception of the instruction command, the packet retransmission module 71 duplicates, based on the instruction command, an advertisement packet similar to the advertisement packet received by the first network interface 24 (S93), and transmits the duplicated advertisement packet via the second network interface 25 by multicasting (S94). Upon completion of the process step of S94, the process flow returns to S91 again. The other process steps are similar to those of the first embodiment.

In this variation, an advertisement packet similar to a received advertisement packet is duplicated and transferred to the LAN side; therefore, even if an advertisement packet is in a non-transferable state, the information of the advertisement packet of a higher level router can be transmitted to a device in a lower level network via the second network interface 25.

### Second Variation of the First Embodiment

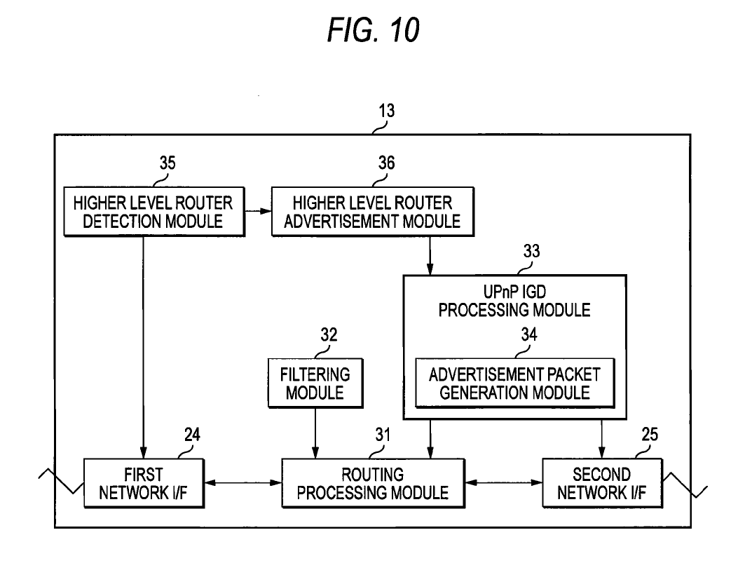

A second variation of the first embodiment according to the present invention will be described with reference to FIGS. 10 to 14.

FIG. 10 is a functional block diagram illustrating one example of functional configuration of a wireless LAN access point 13 according to this variation. As shown in FIG. 10, the wireless LAN access point 13 includes: a first network interface 24; a second network interface 25; a routing processing module 31; a filtering module 32; a UPnP IGD processing module 33; an advertisement packet generation module 34; a higher level router detection module 35; and a higher level router advertisement module 36.

In the functional block diagram in this example, the existing functional blocks are similar to those of the first embodiment by way of example, but the higher level router advertisement module 36 transmits a command to the different block. In this variation, the higher level router detection module 35 detects the existence of a higher level router, and notifies the higher level router advertisement module 36 of the existence of the higher level router. Then, the higher level router advertisement module 36 transmits a command to the UPnP IGD processing module 33 so as to allow the device (PC 14) connected to the second network interface 25 to obtain the setting page of the higher level router (broadband router 12).

Upon reception of this command, the UPnP IGD processing module 33 operates so as to allow the device (PC 14) connected to the second network interface 25 to obtain the setting page of the higher level router (broadband router 12). Two exemplary processes performed by the UPnP IGD processing module 33 in order to allow the PC 14 to obtain the setting page will be given below. In this variation, at least either one of the following two exemplary processes will be performed.

(1) Information included in the advertisement packet of the broadband router 12 is embedded in the advertisement packet of the UPnP IGD function of the present apparatus, i.e., the wireless LAN access point 13.

(2) The URL value of the setting page of the broadband router 12 is pasted into the setting page of the UPnP IGD function of the present apparatus so that when the PC 14 has obtained the setting page based on the information included in the advertisement packet of the wireless LAN access point 13, the PC 14 can further obtain, from this setting page, the setting page of the broadband router 12.

The PC 14 can obtain the setting page(s) by the processes (1) and/or (2).

In the process (1), upon reception of the foregoing command, the UPnP IGD processing module 33 embeds information, stored in the advertisement packet received from the higher level router (broadband router 12), in the advertisement packet of the UPnP IGD function of the present apparatus so as to serve as a generation module to generate an advertisement packet in the advertisement packet generation module 34. Then, the UPnP IGD processing module 33 serves as an advertisement transmission module to transmit the generated advertisement packet from the second network interface 25 by multicasting.

In the process (2), the UPnP IGD processing module 33 serves as a setting page generation module to generate contents of the UPnP IGD function setting page, which can be obtained by an external device. More specifically, conceivable methods include a method for pasting the URL value of the setting page of the broadband router 12 into the setting page of the UPnP IGD function of the present apparatus as described above, but the present invention is not limited to this method.

Although the methods (1) and (2) are illustrated by way of example for setting page obtainment, the present invention is not limited to these methods. Alternatively, the method for allowing the PC 14 to obtain the setting page of the broadband router 12 may be another method.

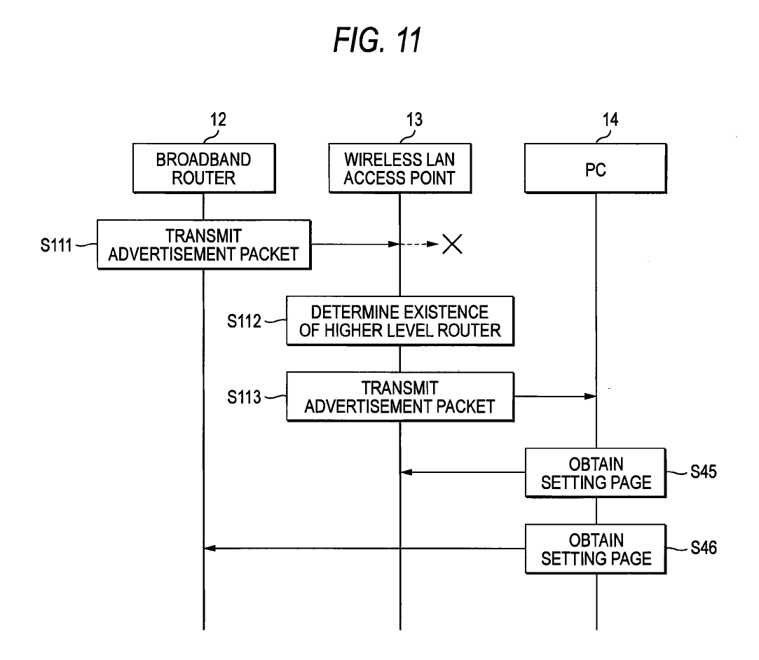

FIG. 11 is a sequence diagram illustrating one example of the flow of communication in the home network system 10 according to second variation of the first embodiment.

In the home network system 10 according to this variation, the communication flow is substantially similar to that of the first embodiment, but the communication corresponding to S43 in FIG. 4 is not performed in this variation. This variation differs from the first embodiment in the following points. In the foregoing process (1), information contained in the advertisement packet of the broadband router 12 is included in the advertisement packet of the wireless LAN access point 13, which is transmitted in S113. Furthermore, in the foregoing process (2), the process step of S113 is similar to the corresponding process step of Variation 1, and the URL of the setting page of the broadband router 12 is pasted into the setting page of the wireless LAN access point 13 when the PC 14 obtains the setting page of the wireless LAN access point 13 in S114; then, using this URL, the PC 14 obtains the setting page provided via the Web function of the higher level router in S115.

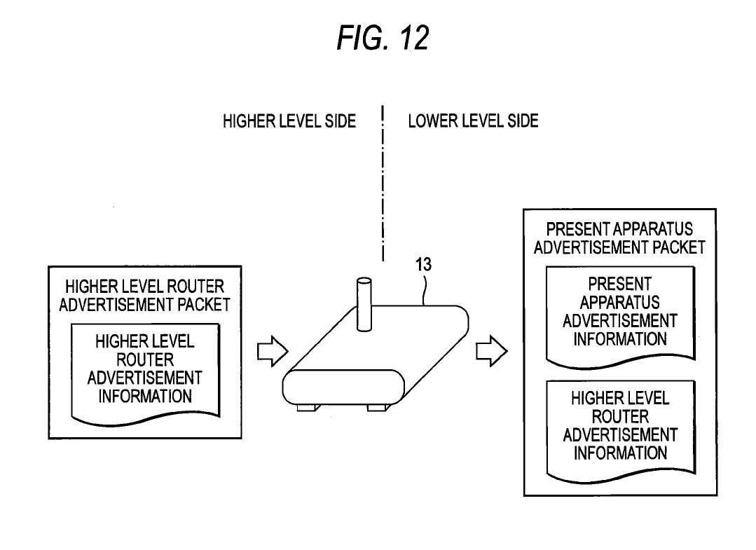

FIG. 12 is a diagram illustrating one example of a method for transferring advertisement packet information according to this variation. This method is a method for transferring advertisement packet information when the process step of the foregoing process (1) is performed.

In the foregoing process (1), as illustrated in FIG. 12, when an advertisement packet is generated by the advertisement packet generation module 34, the wireless LAN access point 13 embeds, in the generated advertisement packet, information included in the advertisement packet of the broadband router 12 (higher level router apparatus) received via the first network interface 24, and transmits, as the advertisement packet of the present apparatus, the generated advertisement packet to the device connected to the second network interface 25.

When the advertisement packet is generated by the advertisement packet generation module 34, the UPnP IGD processing module 33, which has received a command from the higher level router advertisement module 36, embeds the existence of the higher level router and identification information thereof in the generated advertisement packet.

For example, the following tag “foobar: X_TANDEM_ROUTER_DESC” is generated for “Device description” described in an XML format, and information concerning the higher level router apparatus is embedded in this tag. The information to be embedded includes any one or a combination of: a UUID for the UPnP IGD of the higher level router; the URL of “Device description”; and the URL of the setting page. The case in which only the URL value of “Device description” of the higher level router apparatus is included is given below by way of example.

<foobar:X_TANDEM_ROUTER DESC>http://192.168.0.1/description.xml<foobar:X_TANDEM_ROUTER_DESC>

It should be noted that the name of the tag “foobar:X_TANDEM_ROUTER_DESC” in this case is provided by way of example in this variation, and the name of the tag is naturally not limited to this. A user can confirm the information concerning the higher level router apparatus by making reference to “Device description” which is the information stored in the advertisement packet.

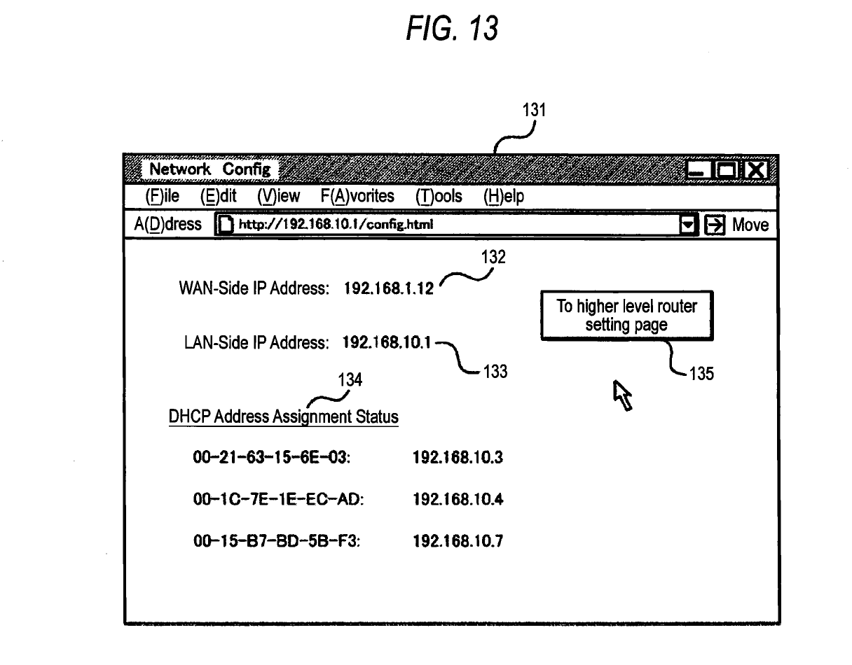

FIG. 13 is a diagram illustrating one example of a UPnP IGD function setting page of the wireless LAN access point 13 according to this variation. In FIG. 13, there are illustrated: a setting page 131; a WAN-side IP address 132; a LAN-side IP address 133; a DHCP address assignment status 134; and a higher level router setting page access button 135.

FIG. 13 is a diagram illustrating the case in which the wireless LAN access point 13 has pasted the URL of the setting page of the higher level router into the setting page 131 of the present apparatus by the foregoing process (2).

The setting page 131 is a Web page that is obtained by the PC 14 from the wireless LAN access point 13 in order to make settings on the UPnP IGD function of the wireless LAN access point 13 in this variation. The PC 14 obtains the setting page 131 from setting page information (URL) stored in the advertisement packet received from the wireless LAN access point 13, and can thus make settings on the wireless LAN access point 13 via the UPnP IGD function. Upon reception of the above-described command by the UPnP IGD processing module 33 from the higher level router advertisement module 36, the reception of this command triggers the UPnP IGD processing module 33 to edit the setting page 131 so that the setting page 131 has a hyperlink to the setting page of the higher level router apparatus. In the setting page 131 in the present embodiment, the WAN-side IP address 132, the LAN-side IP address 133, the DHCP address assignment status 134, and the higher level router setting page access button 135 are presented.

The WAN-side IP address 132 is an IP address of the first network interface 24 of the wireless LAN access point 13.

The LAN-side IP address 133 is an IP address of the second network interface 25 of the wireless LAN access point 13.

The DHCP address assignment status 134 indicates association between MAC addresses (Media Access Control addresses) that are unique addresses of respective devices connected to the second network interface 25, and IP addresses assigned to these devices by the DHCP server function. In the present embodiment, three nodes are connected (nodes other than those associated with the PC 14 are not illustrated), and an IP address is assigned to each of these nodes by the DHCP server function.

The higher level router setting page access button135 is a button for obtaining the setting page of the router apparatus (broadband router 12) existing at a higher level than the wireless LAN access point 13. The hyperlink, to which the URL of the setting page of the higher level router apparatus is pasted, is pasted to the higher level router setting page access button 135, and a user clicks the higher level router setting page access button 135, thereby making it possible to obtain the location of the setting page of the router apparatus existing at a higher level than the wireless LAN access point 13.

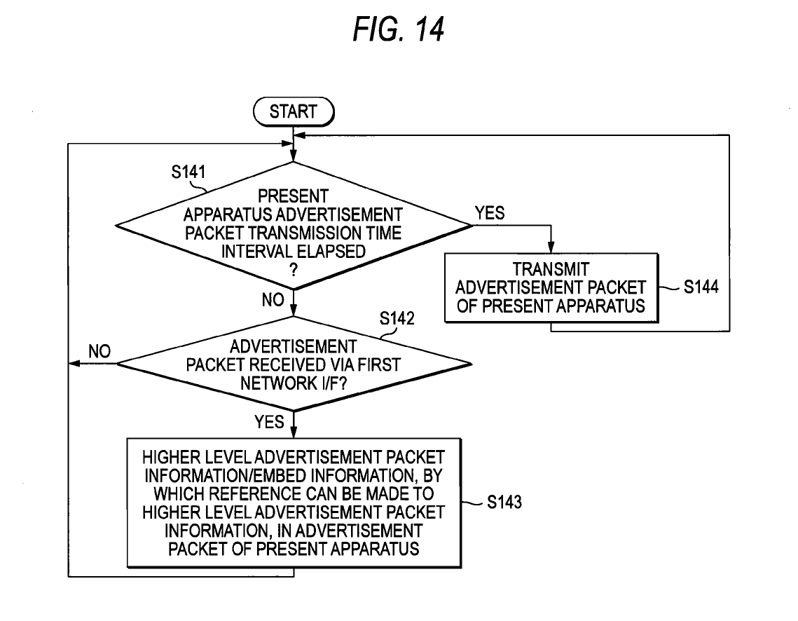

FIG. 14 is a flow chart illustrating one example of process flow of the wireless LAN access point 13 according to this variation. In the process flow of this variation, S141 and S142 correspond to S61 and S62 illustrated in FIG. 6 in the first embodiment, respectively, and therefore, the description thereof will be omitted.

The higher level router advertisement module 36, which has received the notification of the existence of a higher level router apparatus from the higher level router detection module 35 in S142, transmits a command to the UPnP IGD processing module 33 so as to allow the device (PC 14) connected to the second network interface 25 to obtain the setting page of the higher level router (broadband router 12) in S143. Upon reception of this command, the UPnP IGD processing module 33 performs the process (1) or process (2) so that the device connected to the second network interface 25 can obtain the setting page of the higher level router (S143). In this case, the process (1) and process (2) may be combined in S143.

Upon completion of S143, the process flow returns to S141. Then, upon lapse of a transmission time interval (i.e., when the answer is Yes in S141), the advertisement packet including information of the higher level router is transmitted, by multicasting, to the device connected to the second network interface 25 if the process (1) has been performed in S143, but the normal advertisement packet of the present apparatus is transmitted, by multicasting, to the device connected to the second network interface 25 if the process (1) has not been performed in S143.

As a result of the foregoing process flow, the device (PC 14) connected to the second network interface 25 of the wireless LAN access point 13 can obtain the setting page of the higher level router apparatus (broadband router 12).

In this variation, the device (PC 14 in this variation) located at the terminal is given the advertisement packet received from the immediately adjacent higher level router apparatus, together with information of a router apparatus existing at a higher level included in the advertisement packet, thus facilitating the grasping of the locations of the respective router apparatuses even in the multi-stage router configuration. Furthermore, the URL of the setting page of the higher level router is pasted into the setting page of the present apparatus (wireless LAN access point 13), thereby allowing a user to easily perceive the setting page of the higher level router at a glance and to easily make access thereto.

In any method of the first embodiment, the first variation and the second variation, based on the advertisement packet received from the immediately adjacent higher level router apparatus, the information of the higher level router apparatus can be provided to the device connected at a lower level. Hence, even in the case of a multi-stage router configuration including two stages and including three or more router apparatuses, information is provided from the higher level network to the lower level network in sequence. Thus, the device existing at the lowest level also can obtain the information of the router apparatus existing in the home network and advertised by the advertisement packet.

Furthermore, in the first embodiment, the first variation and the second variation, an advertisement packet of a UPnP IGD function is provided as an example of a function advertisement notification, but the present invention is not limited to this; alternatively, as long as the information of the present apparatus is transmitted to the device existing at a lower level side, an advertisement packet irrelevant to a UPnP IGD function may be applicable to the present invention.

The wireless LAN access point 13 provides the information of the higher level router apparatus to the device communicably connected to the second network interface 25 using each of the methods of the first embodiment, the first variation and the second variation, but the present invention is not limited to these methods; alternatively, the information of the higher level router apparatus may be provided using the methods of the first embodiment, the first variation and the second variation in combination.

Although the embodiment according to the present invention has been described above, the present invention is not limited to the above-mentioned embodiment but can be variously modified.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A router apparatus for establishing, in a home network system comprising a plurality of subnetworks including a first subnetwork and a second subnetwork, connection between the respective subnetworks, the router apparatus comprising:
a first network interface configured to be connected to a first communication device existing on the first subnetwork of a higher level side of the router apparatus;
a second network interface configured to be connected to a second communication device existing on the second subnetwork of a lower level side of the router apparatus;
a determination module configured to determine whether a function advertisement notification related to a router device is received from the first communication device; and
a providing module configured to provide, to the second communication device, information included in the function advertisement notification received from the first communication device when the determination module determines that the function advertisement notification related to the router device is received.

2. The apparatus of claim 1,
wherein the function advertisement notification related to the router device is a function advertisement notification of a UPnP IGD function.

3. The apparatus of claim 1,
wherein the providing module comprises a transfer module configured to transfer the function advertisement notification to the second communication device.

4. The apparatus according claim 1,
wherein the providing module further comprises:
a duplication module configured to duplicate the function advertisement notification; and
a duplication transmission module configured to transmit, to the second communication device, the function advertisement notification duplicated by the duplication module.

5. The apparatus according to claim 1,
wherein the providing module further comprises:
a generation module configured to generate a new function advertisement notification related to the apparatus, the new function advertisement notification being embedded with the information included in the function advertisement notification received from the first communication device; and
an advertisement transmission module configured to transmit, via the second network interface, the new function advertisement notification generated by the generation module.

6. The apparatus according to claim 1,
wherein each of the apparatus and the first communication device comprises:
a setting page transmission module configured to transmit, to other devices, a setting page in which a setting can be made on a given function of the respective present apparatus; and
a function advertisement transmission module configured to transmit, as the function advertisement notification, information including the URL of the setting page to other devices existing at a lower level side of the respective present apparatus,
wherein the second communication device comprises a setting module configured to receive the setting page by accessing the URL of the setting page and to make settings on the router apparatus and the first communication device,
wherein the providing module comprises a setting page generation module configured to paste a link to the URL of the setting page to the function advertisement notification received from the first communication device, thereby generating a setting page of the present apparatus, and
wherein the setting page of the present apparatus is transmitted by the setting page transmission module when access is made to the URL of the setting page by the setting module from the second communication device.
